(19) United States
(12) Patent Application Publication
(10) Pub. No.: US 2011/0216806 A1
(43) Pub. Date: Sep. 8, 2011

(54) EAR THERMOMETER WITH EAR CANAL SENSING DEVICE AND MEASUREMENT METHOD THEREOF

(75) Inventor: VINCENT WENG, HSINCHU (TW)

(73) Assignee: RADIANT INNOVATION INC., HSINCHU (TW)

(21) Appl. No.: 12/905,446

(22) Filed: Oct. 15, 2010

(30) Foreign Application Priority Data
Mar. 2, 2010 (TW) 099105943

(51) Int. Cl. G01J 5/00

(52) U.S. Cl. 374/128

(57) ABSTRACT

An ear thermometer with an ear canal sensing device and a measurement method thereof is disclosed. The ear thermometer mainly comprises two sensors. One is an approach sensor installed on a probe. The approach sensor used as the ear canal sensing device determines whether the probe is inserted into an ear canal. Also, the approach sensor is used as the basis to switch the measurement mode to an ear temperature mode or a second measurement mode, such as the forehead temperature mode, surface temperature mode, or room temperature mode. The other is an infrared sensor used to measure temperatures. After the approach sensor determines the measurement mode, the infrared sensor measures the temperature to obtain a signal. Then, the signal is processed through a control module to be shown on a display unit.

### BACKGROUND OF THE INVENTION

1. Field of the Invention

The present invention relates to an infrared ear thermometer, particularly to an ear thermometer with an approach sensor used as an ear canal sensing device, which automatically determines and switches the measurement mode to an ear temperature mode or a second measurement mode, wherein the second measurement mode is a forehead temperature mode, a surface temperature mode, or a room temperature mode.

2. Description of the Related Art

Measuring a body temperature can determine whether a person is inflicted with a fever. Therefore, measuring the body temperature is an important step of the medical diagnosis. The body temperature can be armpit temperature, ear temperature, forehead temperature, under-tongued temperature, and anus temperature, etc. A mercury thermometer or an electronic thermometer is used to measure the armpit temperature, under-tongued temperature, or anus temperature of a person. A probe of an ear thermometer is inserted into an ear canal to measure the ear temperature rapidly utilizing the infrared technology. An offset mouth temperature is added to the ear temperature to obtain an effective mouth temperature, which is displayed on the ear thermometer. With the infrared technology, a forehead thermometer rapidly scans to measure the forehead temperature without touching or slightly touching the skin of the forehead. In addition, the forehead thermometer touches the skin of the forehead to measure the forehead temperature rapidly. An offset mouth temperature is added to the forehead temperature to obtain an effective mouth temperature, which is displayed on the forehead thermometer. The electronic thermometer is a popular medical tool for household usage but it needs longer time to measure. However, the ear thermometer and the forehead thermometer can rapidly finish measuring temperature within a few seconds.

The ear thermometer and the forehead thermometer function by means of the infrared technology. Also, the measuring positions for the ear thermometer and the forehead thermometer are different. As a result, there is a 2-in-1 thermometer measuring the ear temperature and the forehead temperature in the market. In order to coordinate the irradiation and the offset mouth temperature at different measuring positions, all the 2-in-1 thermometers are operated manually by users. As to a certain switching mechanism, the 2-in-1 thermometer is controlled by a touching switch or a pressing button to switch to its measurement mode, so as to measure a correct body temperature. Nevertheless, the manual switching mechanism can not prevent the user from switching the mode incorrectly. Besides, when the measurement mode is switched by the touching switch, the doubt of the switching reliability still exists as well, such as the problem caused by a rusty switch. Once the measurement mode is switched incorrectly, then the body temperature measured is in error.

In view of the problems and shortcomings of the prior art, the present invention provides an automatic thermometer for determining a measurement mode and a measurement method thereof, which adopts an approach sensor used as an ear canal sensing device, whereby the afore-mentioned problems of the prior art are solved. Below, the embodiments and the specific method are described.

### SUMMARY OF THE INVENTION

A primary objective of the present invention is to provide an ear thermometer with an ear canal sensing device, which adopts an approach sensor installed on a probe to determine whether the probe is inserted into the ear canal, no as to switch between two types of measurement modes automatically. Wherein, one type is the ear temperature mode, which means that the probe is inserted into the ear canal; and the other type is the second measurement mode, which means that the probe is not inserted into the ear canal, wherein the second measurement mode is the forehead temperature mode, the surface temperature mode, or the room temperature mode. The user does not have to switch between the measurement modes manually. Therefore, the ear thermometer is prevented from the error in measuring the body temperature due to the incorrect mode. Also, the degree of the friendliness for operating the thermometer is enhanced.

To achieve the abovementioned objective, the present invention provides an ear thermometer with an ear canal sensing device, comprising: a body with a probe, a first sensor for sensing distances, a second sensor for sensing temperatures, a control module, and a display unit. The first sensor installed on the probe determines whether the probe is inserted into an ear canal, so as to determine the measurement mode automatically. When the measurement button is pressed, the control module drives the second sensor into measuring temperatures with infrared rays according to the determined measurement mode. The temperature is calculated through utilizing an offset mouth temperature to obtain an effective temperature. The control module will control the display unit to show the measurement mode and the effective temperature.

The present invention also provides a measurement method for an ear thermometer with automatic measuring function, comprising the steps of: disposing a first sensor on a probe to determine whether the probe is inserted into an ear canal from the outside the ear canal; if yes, automatically starting a second sensor to measure ear temperatures and showing the temperature-measuring result on a display unit.

The present invention further provides a measurement method for an ear thermometer, which determines whether a user uses the ear thermometer correctly, comprising the steps of: disposing a first sensor on a probe and determining whether said probe is deeply inserted into an ear canal; if no, outputting an acoustic-optical warning message after pressing down a measurement button to warn the user of the incorrect operation.

Below, the embodiments are described in detail in cooperation with the drawings to make easily understood the characteristics, technical contents and accomplishments of the present invention.

### BRIEF DESCRIPTION OF THE DRAWINGS

FIG. 1 is a perspective view showing an ear thermometer with an ear canal sensing device according to an embodiment of the present invention;

FIG. 2a and FIG. 2b are diagrams respectively schematically showing the execution of the ear temperature measurement and the forehead temperature measurement according to an embodiment of the present invention;

FIG. 3 is a block diagram showing the steps of the measurement method for determining the measurement mode automatically; and

FIG. 4 is a diagram schematically showing the application of the ear temperature measurement and the display result according to an embodiment of the present invention.

### DETAILED DESCRIPTION OF THE INVENTION

The present invention provides an automatic thermometer for determining automatically a measurement mode and a measurement method thereof, which provides various measurement modes to switch among them, wherein the thermometer itself determines its surrounding environment to select the measurement mode automatically.

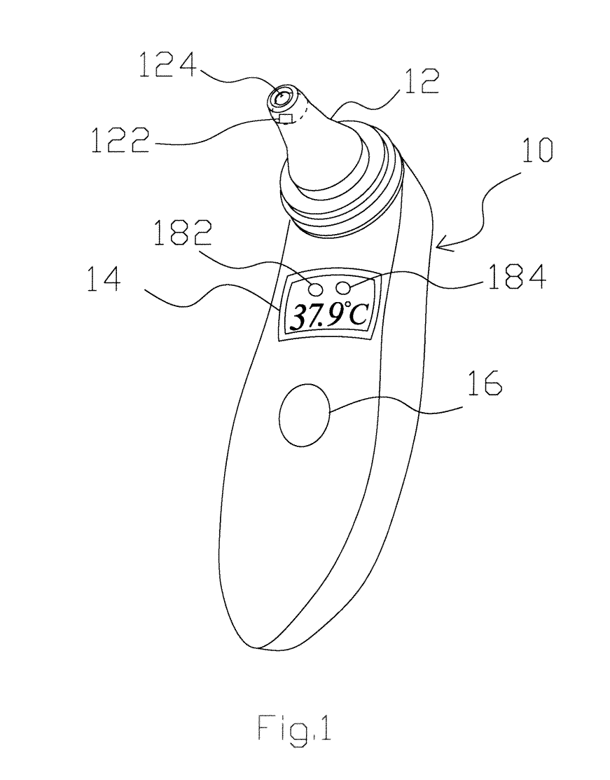

FIG. 1 is a perspective view showing a thermometer according to an embodiment of the present invention. A probe 12, which is disposed on a thermometer body 10, has a shape similar to a cone. An approach sensor 122 and an infrared sensor 124 are disposed inside the probe 12, and the approach sensor 122 can be an optical approach sensor or a capacitive approach sensor. A display unit 14 and a measurement button 16 are further disposed on the thermometer body 10, wherein the measurement button 16 is coupled to a control module (not shown) disposed in the interior of the thermometer. The control module not only drives the approach sensor 122 and the infrared sensor 124 but also displays the sensed temperature on the display unit 14.

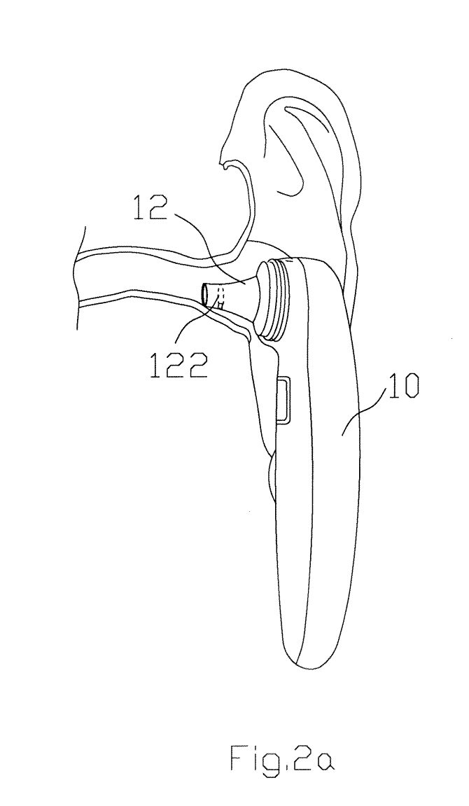

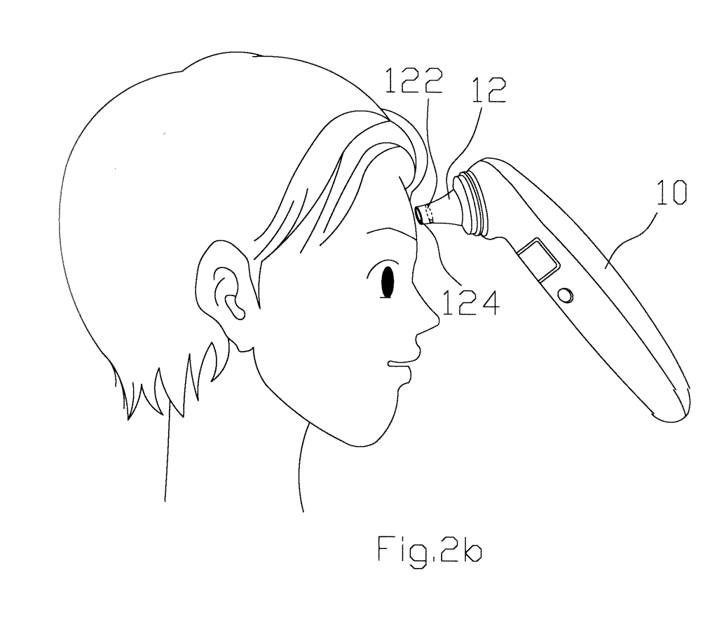

The approach sensor 122 is installed on the probe 12 of the ear thermometer. As shown in FIG. 2a and FIG. 2b, which show the different application states for the approach sensor 122. FIG. 2a is a diagram schematically showing the application of the ear temperature measurement. FIG. 2b is a diagram schematically showing the application of the forehead temperature measurement. In FIG. 2a, the probe 12 is inserted into the ear canal such that the skin of the ear canal is either very close to or even touches the approach sensor 122. In FIG. 2b, a distance is maintained between the approach sensor 122 and the forehead. As a result, the approach sensor 122 installed on the probe 12 can be used as an ear canal sensing device, which determines whether the probe 12 is inserted into the ear canal.

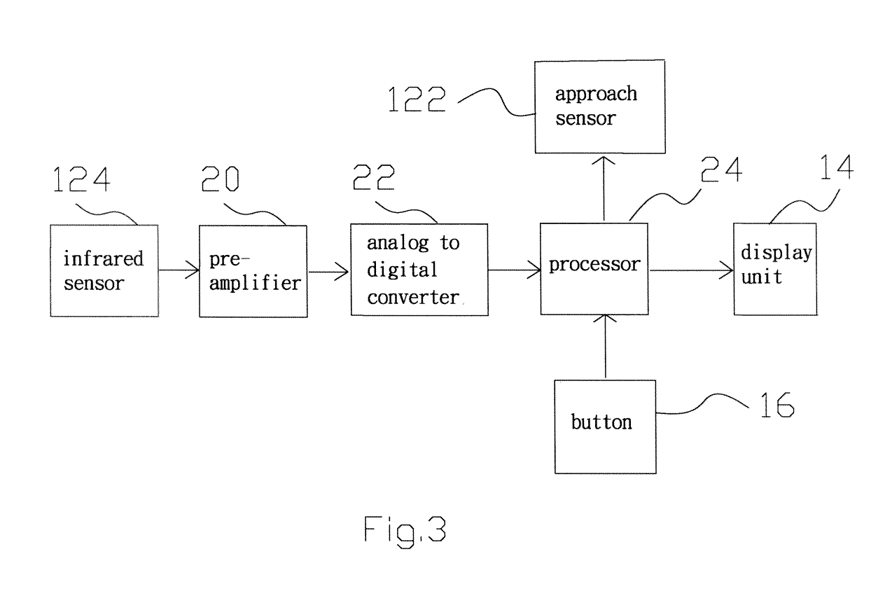

Refer to FIG. 3. The following is the description of the operation of the control module in the thermometer. The control module is composed of a preamplifier 20, an analog-to-digital converter 22, and a processor 24. The approach sensor 122 is coupled to the processor 24, and the infrared sensor 124 is coupled to the preamplifier 20. Refer to FIG. 1 and FIG. 3. When the thermometer body 10 is pressed and the measurement button 16 is pressed down, the thermometer will determine the measurement mode based on the sensing result detected by the approach sensor 122. If an object is sensed within the sensing range of the approach sensor 122, which means that the probe 12 is inserted into the ear canal, the approach sensor 122 will send out a signal to the processor 24, so as to determine the measurement mode as an ear temperature mode. If an object is not sensed within the sensing range of the approach sensor 122, the measurement mode is switched to a second measurement mode. At this time, according to the determined measurement mode, the infrared sensor 124 not only begins measurement using infrared ray according to the measurement mode determined, but also sends out an electric signal corresponding to the infrared rays, wherein the electric signal is an analog signal. The preamplifier 20 amplifies the electric signal, and then the electric signal is converted into a digital signal by the analog-to-digital converter 22. Next, the digital signal is transmitted to the processor 24 for processing. The processor 24 performs an operation on the signal to obtain the temperature of an object-to-be-tested. Furthermore, the processor 24 appropriately adds an offset mouth temperature to the temperature of the object-to-be-tested. Finally, the processor 24 controls the display unit 14 to show the final temperature and the measurement mode determined by the approach sensor 122. As shown in FIG. 1, a first mode display symbol 182 and a second mode display symbol 184 are the symbols having the representative meaning, such as the ear pattern displayed in the ear temperature mode, the forehead pattern displayed in the forehead temperature mode, and the potted plant pattern displayed in the room temperature mode, etc. Besides, the two mode display symbols 182 and 184 can be the lamp indicators.

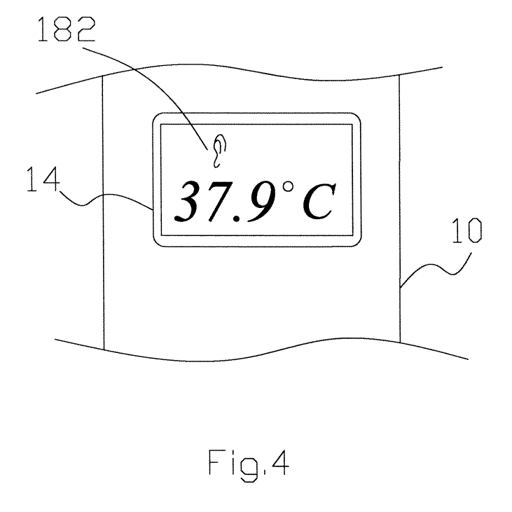

FIG. 4 is a diagram schematically showing the application of the ear temperature measurement and the display result according to an embodiment of the present invention. The ear temperature mode of the measurement mode is displayed on the display unit 14 of the thermometer body 10. Also, the ear pattern appears in the position of the first mode display symbol 182. A user can clearly realize which measurement mode performed according to the pattern. In addition, an ear temperature of 37.9 is displayed under the ear pattern.

The sensing range of the approach sensor of the present invention is about 2 mm. Therefore, if the distance between an object and the approach sensor is greater than 2 mm, then the measurement mode is switched to the second mode. On the contrary, if the object is sensed within 2 mm, the measurement mode is switched to the ear temperature mode. The present invention provides the measurement modes comprising three types of measurement mode combinations. The first measurement mode is the ear temperature mode, since the object sensed is within the sensing range of the approach sensor. When the distance between the object and the approach sensor is larger than the sensing range of the approach sensor, the second measurement mode is performed. The second measurement mode is the forehead temperature mode, the surface temperature mode, and the room temperature mode, etc. As a result, the three types of the measurement mode combinations are an ear-forehead temperature measurement mode, an ear-surface temperature measurement mode, and an ear-room temperature measurement mode respectively.

It has to be noted that the distance between the approach sensor and the front end of the probe has to be greater than the sensing range of the approach sensor necessarily. For instance, when the sensing range is between 0 and 2 mm, then the distance between the approach sensor and the front end of the probe is greater than 2 mm., thus preventing the approach sensor from misjudging measuring the forehead temperature as measuring the ear temperature.

The present invention further provides a measurement method for an ear thermometer. Refer to FIG. 1 and FIG. 3. After starting the thermometer body 10, the approach sensor 122 continuously sends out a sensing signal to the processor 24. When the processor 24 observes that the measured position moves from outside the sensing range of the approach sensor 122 to inside the sensing range of the approach sensor 122 according to the state of the sensing signal, the processor 24 determines that the user is inserting the probe 12 into the ear canal. At this time, the processor automatically controls the infrared sensor 124 to measure the temperature, and then the infrared sensor 124 sends out a temperature signal, wherein the temperature signal is an analog signal. Firstly, the preamplifier 20 amplifies the temperature signal, and then the analog-to-digital converter 22 converts the temperature signal into a digital signal and sends out the digital signal to the processor 24 for further processing. Finally, the processor 24 controls the display unit 14 to show the temperature detected by the infrared sensor 124. In other words, the ear thermometer of the present invention is capable of the automatic measuring function. After starting the ear thermometer, the user has only to insert it into the ear canal to obtain an ear temperature, thus achieving the most simplified and easy operation.

The present invention further provides a measurement method for determining whether a user utilizes a thermometer correctly. Refer to FIG. 1 and FIG. 3. After pressing the thermometer body 10 and pressing down the measurement button 16, the processor 24 reads the sensing result as sensed by the approach sensor 122. In case it is sensed that, the object is within the sensing range of the approach sensor 122, which means that the probe 12 is inserted into the ear canal deeply, such that the approach sensor 122 is placed inside the ear canal. On the other hand, in case it is sensed that the object is not within the sensing range of the approach sensor 122, which means that the user does not insert the probe 12 into the ear canal correctly. Also, the ear thermometer will send out an acoustic-optical warning message to warn the user of the incorrect operation. Therefore, the ear thermometer not only has a function for determining whether a user correctly operates but also gives out a warning message, so as to help the user utilize the ear thermometer more correctly.

In conclusion, the present invention provides a thermometer with an ear canal sensing device and a measurement method (hereof, which adopts an approach sensor to determine the position of the probe automatically. According to the sensitivity (sensing range) of the approach sensor, the approach sensor can automatically determine whether the probe is placed inside the ear canal. A control module is capable of switching between the measurement modes to the ear temperature mode or the second measurement mode. As a result, the user does not have to switch between the measurement modes manually, so as to reduce the measurement errors due to the incorrect operation. Besides, it is more convenient and friendly for the user to operate the thermometer. The embodiments described above are only to exemplify the present invention but not to limit the scope of the present invention. Therefore, any equivalent modification or variation according to the shape, structures, characteristics and spirit disclosed in the present invention is to be also included within the scope of the present invention.

What is claimed is:

1. An ear thermometer with an ear canal sensing device comprising:
a body, comprising a probe;
a first sensor, disposed on said probe at a distance from a front end of said probe, said first sensor, which is used as a basis to determine a measurement mode, determines whether said probe insert into an ear canal;
a second sensor, disposed inside said probe to detect at least one infrared signal;
a control module, coupled to a button, said first sensor, and said second sensor, wherein when said button is pressed, said control module determines that said measurement mode is an ear temperature mode or a second measurement mode as based on said first sensor, and then starts said second sensor to measure a temperature and perform an operation, and a temperature-measuring result is transmitted back to said control module; and
a display unit, disposed on said body and coupled to said control module, and said temperature-measuring result is shown on said display unit.

2. The ear thermometer with the ear canal sensing device according to claim 1, wherein said second measurement mode is a forehead temperature measurement mode, a surface temperature measurement mode, or a room temperature measurement mode.

3. The ear thermometer with the ear canal sensing device according to claim 1, wherein said display unit shows said temperature-measuring result and measurement mode symbols.

4. The ear thermometer with the ear canal sensing device according to claim 1, wherein said control module comprises an preamplifier, an analog-to-digital converter, and a processor; said control module amplifies a temperature signal detected by said second sensor and converts said temperature signal into a digital signal, which is provided to said processor for processing.

5. The ear thermometer with the ear canal sensing device according to claim 1, wherein said first sensor is an optical approach sensor or a capacitive approach sensor.

6. The ear thermometer with the ear canal sensing device according to claim 1, wherein said first sensor is disposed on a side of said probe; when said object is placed within a sensing distance of said first sensor, said first sensor used as an ear canal sensing device determines that said probe is placed inside an ear canal.

7. The ear thermometer with the ear canal sensing device according to claim 6, wherein said distance between said first sensor and said front end of said probe is greater than 2 mm.

8. The ear thermometer with the ear canal sensing device according to claim 6, wherein said distance between said first sensor and said front end of said probe is larger than a sensing range of said first sensor.

9. A measurement method for an ear thermometer comprising steps of:
disposing a first sensor on a probe, and determining whether said probe approaches an object to determine whether said probe is inserted into an ear canal from outside said ear canal; if yes, automatically measuring an ear temperature; and
utilizing a display unit to show a temperature-measuring result.

10. A measurement method for an ear thermometer, comprising steps of:
disposing a first sensor on a probe, and determining whether said probe approaches an object to determine whether said probe is inserted into an ear canal, such that said first sensor is at a shortest distance from skin of said ear canal; if no, outputting a warning message after pressing a measurement button.
